(19) United States
(12) Patent Application Publication
(10) Pub. No.: US 2025/0361708 A1
(43) Pub. Date: Nov. 27, 2025

(54) BIDET ENERGY HARVESTING

(71) Applicant: Kohler Co., Kohler, WI (US)

(72) Inventors: Tony L. Lambert, Sheboygan, WI (US); Michael Smith, Sheboygan, WI (US)

(21) Appl. No.: 19/199,083

(22) Filed: May 5, 2025

Related U.S. Application Data
(60) Provisional application No. 63/651,785, filed on May 24, 2024.

(51) Int. Cl. E03D 9/08; F03B 13/10

(52) U.S. Cl. CPC E03D 9/08; F03B 13/10; F05B 2270/341; F05B 2270/504

(57) ABSTRACT

A bidet includes a wand configured to be coupled to a toilet and dispense a flow of water, a manual flow regulator configured to control a flow rate of the flow of water dispensed by the wand, a hydraulic turbine configured to generate power as water is supplied to the toilet or the wand, and an electronic valve configured to control the flow of water dispensed from the wand using power generated by the hydraulic turbine.

### CROSS-REFERENCE TO RELATED APPLICATION

This application claims priority benefit of Provisional Application No. 63/651,785 (Docket No. 010222-24001A) filed on May 24, 2024, which is hereby incorporated by reference in its entirety.

### FIELD

The present disclosure relates to generally to the field of bidets. More specifically, the present disclosure relates to electronic bidets.

### BACKGROUND

Generally, a toilet may include a bidet configured to wash an underside of a user, thereby improving a user experience. Some toilets include integrated bidets. After-market bidets configured to be coupled to existing toilets are also available. Bidets may allow users to control characteristic of a flow of water dispensed. However, water control functionalities are typically implemented using complex control systems requiring large amounts of power or require a user to manually adjust the bidet according to their preferred settings with each use of the bidet. Accordingly, there is a need for a more efficient bidet that consumes less power and that does not require a user to manually adjust the bidet in accordance with their preferred settings with each use.

### BRIEF DESCRIPTION OF THE DRAWINGS

Objects, features, and advantages of the present disclosure should become more apparent upon reading the following detailed description in conjunction with the drawing figures, in which:

FIG. 1 illustrates a perspective view of a toilet in accordance with one example of the present disclosure. Specifically, FIG. 1 illustrates a toilet including a tank in accordance with one example of the present disclosure.

FIG. 2 illustrates a perspective view of a toilet in accordance with one example of the present disclosure. Specifically, FIG. 2 illustrates a tankless toilet in accordance with one example of the present disclosure.

FIG. 3 illustrates a bidet assembly in accordance with one example of the present disclosure.

FIG. 4 illustrates a toilet in accordance with one example of the present disclosure.

FIG. 5 illustrates a bidet wand in accordance with one example of the present disclosure.

FIG. 6 illustrates a control panel in accordance with one examples of the present disclosure.

FIG. 7 illustrates a toilet in accordance with one example of the present disclosure.

FIG. 8 illustrates a toilet in accordance with another example of the present disclosure.

FIG. 9 illustrates a toilet in accordance with yet another example of the present disclosure.

FIG. 10 illustrates a flow chart for operation of a bidet assembly in accordance with one example of the present disclosure.

FIG. 11 illustrates an apparatus for controlling a bidet assembly in accordance with one example of the present disclosure.

### DETAILED DESCRIPTION

Described herein are devices, systems, and methods for washing a user with a bidet. The devices, systems, and methods described herein may include or use a manual flow regulator, an electronic valve, and a hydraulic turbine. The flow regulator may control a flow rate and/or pressure of water dispensed from the bidet wand. In accordance with some examples of the present disclosure, a user may (e.g., manually, physically) adjust a position of the flow regulator to a position corresponding to a desired or preferred flow rate of water. After being adjusted or set once by a user, the flow regulator may remain in the position set by the user for multiple use cycles (e.g., sequences of turning on and off a flow of water from the bidet). For example, the flow regulator may remain in the position set by the user for multiple use cycles of the bidet as opposed to the flow regulator also being used to stop water from being dispensed from the wand (e.g., by being moved to a position in which a pathway of water to an outlet of the bidet is completely blocked).

An electronic valve may control water provided to an outlet of the bidet wand. Specifically, an electronic valve may be configured or operable to move between an open position in which water flows through the valve to an outlet of the bidet wand and thus is dispensed from the bidet and a closed position in which water is prevented from flowing through the valve and thus is not dispensed from the bidet. According to some examples, the electronic valve may be a binary valve configured to actuate or move between a single open position and a single closed position.

In accordance with some examples of the present disclosure a manual flow regulator and an electronic solenoid valve may be used in combination in order to provide users a high degree of customizability with respect to a flow rate of water dispensed via the flow regulator while not requiring users to manually set preferences with each use and limiting an amount of power required. Specifically, according to some examples of the present disclosure, a manual flow regulator may be used to control a flow rate of water dispensed from the bidet obviating the need to electronically store and access user settings, the need for a user interface and a procedure for adjusting a position of a variable position electronic valve, and/or the need for a variable position electronic valve.

A hydraulic turbine may be configured to generate power as water flows to a bidet or toilet (e.g., to which the bidet is coupled, including the bidet). The hydraulic turbine may generate power for consumption by the electronic valve. According to some examples, the electronic valve may be powered solely using power generated by the hydraulic turbine. Accordingly, a bidet, bidet system, or toilet including a bidet according to the present disclosure may be provided as a stand-alone of self-sustaining system that does not require power from an external source, for example, a wall outlet.

The hydraulic turbine and the flow regulator may be provided in a housing. According to some examples, the housing may be disposed separately and remotely from the bidet wand and/or a toilet (e.g., to which the bidet is coupled, including the bidet). For example, the housing may be disposed in a pedestal of a toilet, outside of a toilet, in a wall or floor (e.g., proximate to the toilet) or the like.

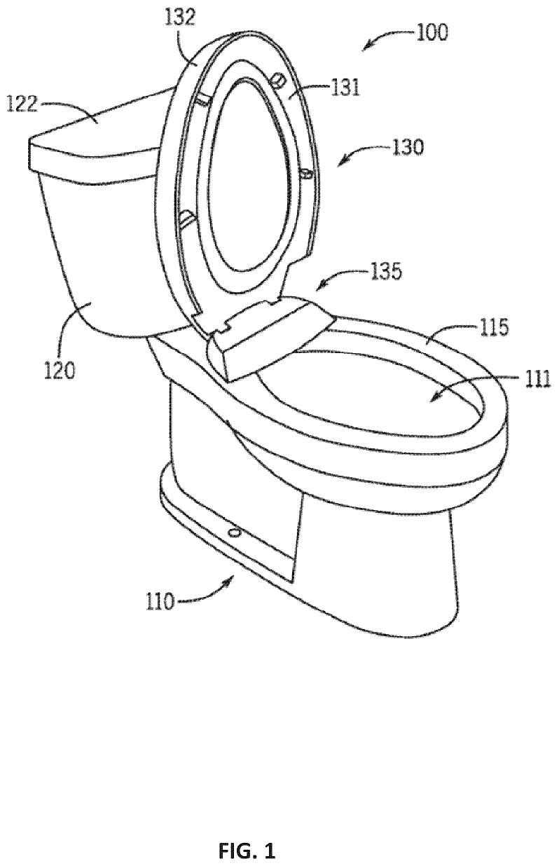

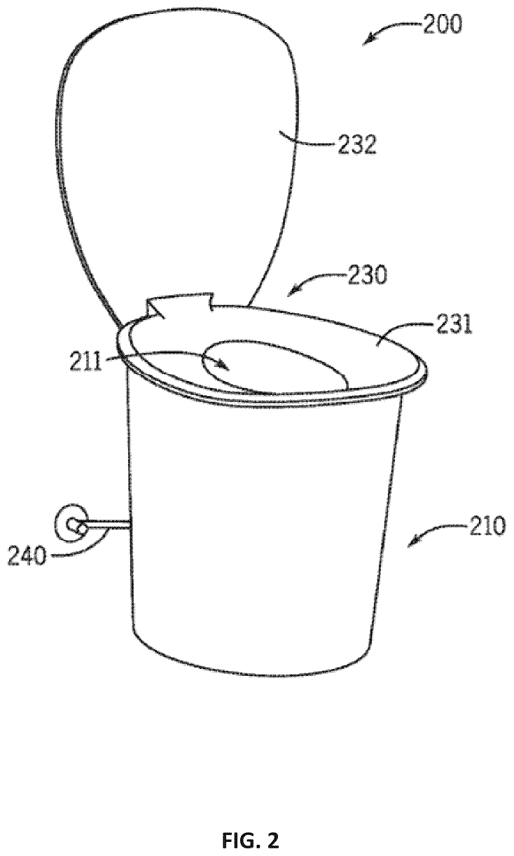

FIGS. 1 and 2 illustrate exemplary embodiments of toilets that may include a bidet assembly according to the present disclosure. The seats 131, 231 described hereinafter and included in the toilets 100, 200, respectively, may be a toilet seat according to the present disclosure.

Referring to FIG. 1 a toilet 100 including a base 110 (e.g., a pedestal, etc.) and a tank 120 is shown. The base 110 is configured to be attached to another object such as a drainpipe, floor, or another suitable object. The base 110 includes a bowl 111, a sump (e.g., a receptacle) disposed below the bowl 111, and a trapway fluidly connecting the bowl 111 to a drainpipe or sewage line. The tank 120 may be supported by the base 110, such as an upper surface of a rim 115. The tank 120 may be integrally formed with the base 110 as a single unitary body. In other embodiments, the tank 120 may be formed separately from the base 110 and coupled (e.g., attached, secured, fastened, connected, etc.) to the base 110. The toilet 100 may further include a tank lid 122 covering an opening and inner cavity in the tank 120. The toilet 100 may include a seat assembly 130 including a seat 131 and a seat cover 132 rotatably coupled to the base 110. The toilet 100 may further include a hinge assembly 135.

Referring to FIG. 2, a tankless toilet 200 is shown. The toilet 200 includes a base 210 and a seat assembly 230 coupled to the base. The base 210 includes a bowl 211, a sump disposed below the bowl 211, and a trapway fluidly connecting the bowl 211 to a drainpipe or sewage line. The toilet 200 includes a waterline 240 that supplies the toilet 200 with water. The toilet 200 may further include a seat assembly 230 including a seat 231 and a seat cover 232 rotatably coupled to the base 210. The toilets 100 and 200 of FIGS. 1 and 2 are provided herein as non-limiting examples of toilets that may be configured to utilize aspects of the present disclosure.

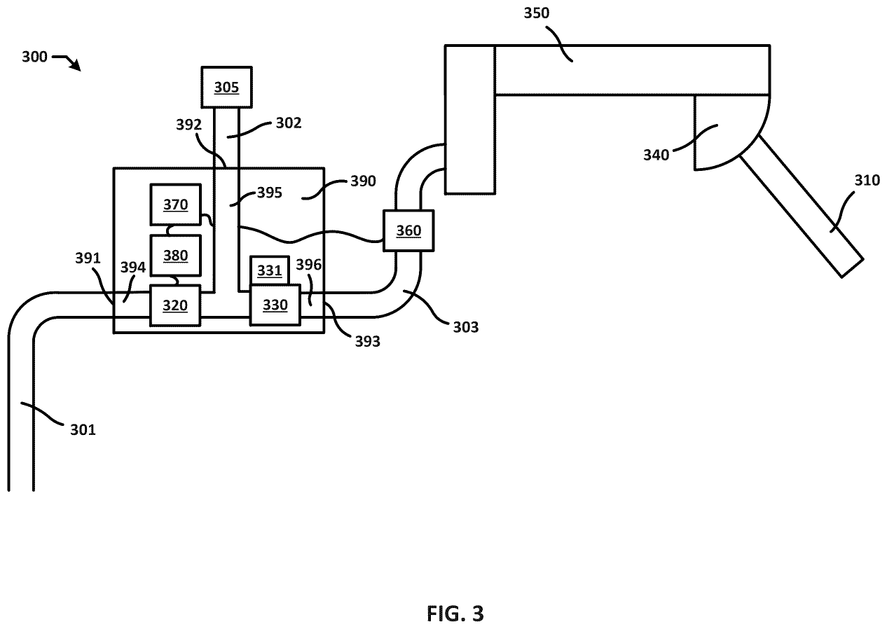

Referring to FIG. 3, a bidet assembly 300 is illustrated in accordance with one example of the present disclosure. As shown in FIG. 3, the bidet assembly 300 may include a wand 310, a hydraulic turbine 320, and an electronic valve 360.

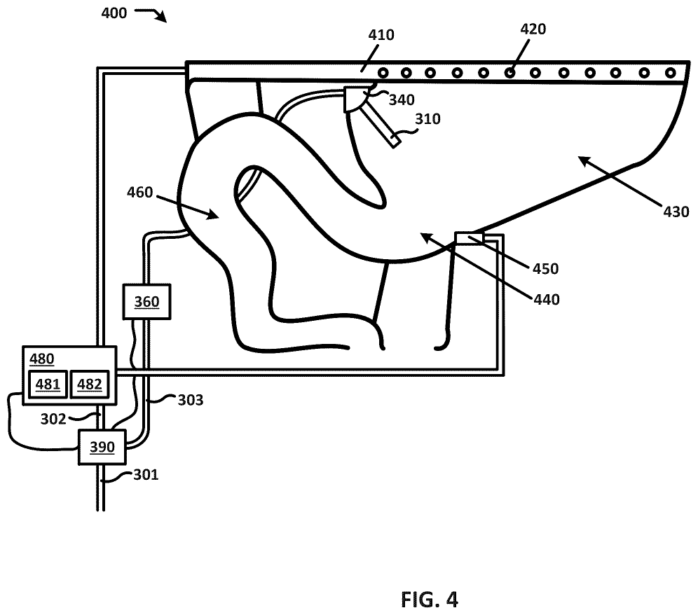

In some examples, as illustrated in FIG. 3, the bidet assembly 300 may include a wand housing 340. In some examples, as shown in FIG. 3, the wand housing 340 may be integrally formed as a part of or coupled to a bidet base 350 configured to be coupled to a toilet (e.g., 100, 200), for example, as an after-market or add-on product. In other examples, as shown in FIG. 4, the wand housing 340 may be integrally formed as a part of or couple to a pedestal or base (e.g., 110, 210) of a toilet (e.g., 100, 200).

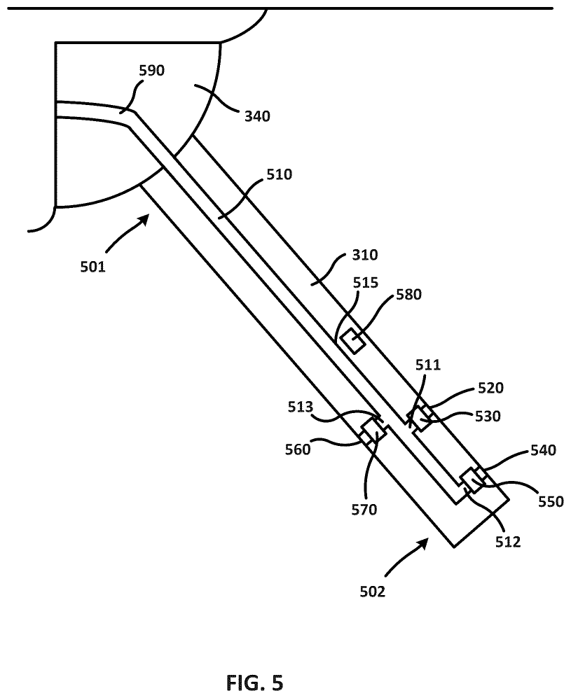

As shown in FIG. 3, the wand 310 may extend from the wand housing 340. In some examples, the wand 310 may be integrally formed with the wand housing 340. In other examples, the wand 310 may be separately formed and subsequently coupled to the wand housing 340. The wand 310 may include a proximal end disposed at and/or coupled to the wand housing 340 and a distal end opposite the proximal end. When the bidet assembly 300 is coupled to a toilet, the distal end of the wand 310 may be disposed more near to center of the toilet bowl (e.g., 111, 211) than the proximal end. The wand 310 may be configured to dispense a flow of water for washing a user. For example, the wand 310 may be configured to dispense a flow of water upward and outward (e.g., radially inward toward a center of the bowl), so that the flow of water contacts a user, washing a user, and subsequently falls into the bowl. The wand 310 is described hereinafter in greater detail with respect to FIG. 5.

As shown in FIG. 3, the bidet assembly 300 may further include a bidet base 350. In some examples, as shown in FIG. 3, the wand housing 340 may be integrally formed with or formed separately from and subsequently coupled to the bidet base 350. The bidet base 350 may be configured to couple the wand housing 340 and/or wand 310 to a toilet (e.g., 100, 200). For example, the bidet base 350 may couple the wand housing 340 and/or wand 310 to a pedestal or base (e.g., 110, 210) of a toilet (e.g., 100, 200). The bidet base 350 may be configured to rest or sit on a top surface of the pedestal or base (e.g., 110, 210) of a toilet.

In some examples, the bidet base 350 may be configured to be coupled to a toilet, so as to be disposed between a top surface of the pedestal or base and a seat assembly (e.g., 130, 230) coupled the pedestal or base. For example, the bidet base 350 may include one or more mounting holes, the one or mounting holes may align with corresponding holes in a top surface of the pedestal or base and a fastener may be inserted through a portion (e.g., hinge shoulder) of the seat assembly, through a mounting hole included in the bidet base 350, and into a corresponding hole in the pedestal or base, coupling the bidet base 350 and the seat assembly to the pedestal. In other examples, the bidet base 350 may be separately or individually coupled to the pedestal of a toilet.

The bidet assembly 300 may further include a hydraulic turbine 320. The hydraulic turbine 320 may be disposed along or within a conduit or pathway along which water is conveyed to the wand 310 and/or a toilet to which the bidet assembly 300 is coupled or which includes the bidet assembly 300. The hydraulic turbine 320 may be disposed along a conduit or pathway extending between a water supply, for example, a potable water plumbing network (e.g., commercial or residential building water supply), and the wand 310. The hydraulic turbine 320 may be configured to generate power as water flows to the wand 310 and/or a toilet (e.g., to which the bidet assembly 300 is coupled, including the bidet assembly 300).

The hydraulic turbine 320 may be configured to generate power (i.e., electric current) as fluid flows past the hydraulic turbine 320. Specifically, the hydraulic turbine 320 may include an impeller disposed in a pathway or conduit through which fluid (e.g., water) flows. As water flows through the pathway or conduit in which the impeller is disposed, water may contact the impeller, causing the impeller to rotate. The hydraulic turbine 320 may include one or more magnets and one or more coils configured to generate power as fluid flows past the impeller, rotating the impeller.

The bidet assembly 300 may further include a flow control valve or a flow regulator 330. The flow regulator 330 may be disposed along a conduit or channel through which water is supplied to the wand 310. The flow regulator 330 may be configured to control any one, any combination, or all of: (i) a flow rate; (ii) a velocity; or (iii) a pressure of water dispensed by the wand 310. In some examples, as shown in FIG. 3, the flow regulator 330 may be disposed downstream, with respect to a flow of water from the water supply to the wand 310, of the hydraulic turbine 320. In other examples, the flow regulator 330 may be disposed upstream, with respect to a flow of water from the water supply to the wand 310, of the hydraulic turbine.

The flow regulator 330 may be configured to vary or restrict a cross-sectional area of a channel or conduit through which water flows to the wand 310. The flow regulator 330 may include a movable element disposed within the flow path of a channel or conduit through which water flows to the wand 310. In accordance with the present disclosure, the flow regulator 330 may be a manual flow regulator including an actuator 331 configured to be manipulated or moved by a user. For example, the flow regulator 330 may include an actuator 331 comprising a knob, lever, or the like configured to be moved by a user. As the actuator 331 is moved, a position of the movable element within the flow path and a cross-sectional area of the channel or conduit through which water may flow are varied. In some examples, an angular position of the actuator 331 (e.g., lever, knob) may correspond to a cross-sectional area of the channel or conduit which is not blocked by the movable element and through which water may flow to the wand 310. The movable element may be a plug, a needle, or the like. As the cross-sectional area of the channel or conduit changes, the flow rate and/or velocity of water that is able to pass through the channel or conduit (e.g., around the movable element) and is dispensed from the wand 310 also changes.

In some examples, the flow rate of water dispensed by the wand 310 may be the same as the flow rate of water provided to the wand 310 (e.g., through a channel or conduit included the flow regulator 330). In other examples, the flow rate of water dispensed by the wand 310 may be different than the flow rate of water provided to the wand 310. However, even when the flow rate of water dispensed from the wand 310 is different that the flow rate of water provided to the wand 310 (e.g., due to channel geometry, a fluidic device, for example a nozzle, or the like) the flow rate of water dispensed from the wand 310 may vary (e.g., proportionally) based on the flow rate of water provided to the wand 310.

The bidet assembly 300 may further include an electronic valve 360 disposed along a conduit or channel through which water may be conveyed to the wand 310. The electronic valve 360 may control a flow of water dispensed by the wand 310. Specifically, the electronic valve 360 may be configured to control whether or not water is dispensed from the bidet wand 310. The electronic valve 360 may be configured or operable to move between an open position in which water flows through the valve (e.g., to an outlet of the bidet wand) and thus is dispensed from the bidet and a closed position in which water is prevented from flowing through the valve and thus is not dispensed from the bidet. According to some examples, the electronic valve may be a binary valve configured to actuate or move between a single open position and a single closed position. For example, using a binary valve, which is not configurable or operable to move to any position other than a single open position and a single closed position (e.g., is not configurable or operable to open a variable degree) may reduce power requirements and/or the complexity of a system for controlling the electronic valve 360.

In some examples, the electronic valve 360 may be disposed outside of the bidet wand 310, for example, between a water supply (e.g., a potable water plumbing network) and the bidet wand 310. In these examples, the electronic valve may control a flow of water provided to the bidet wand 310 (e.g., whether or not a flow of water is provided to the bidet wand 310), and thus a flow of water dispensed from the bidet wand 310 (e.g., whether or not a flow of water is dispensed from the wand 310). For example, the electronic valve 360 may allow or prevent a flow of water from flowing to the bidet wand 310, and thus allow or prevent a flow of water from being dispensed from the bidet wand 310. In some examples, the electronic valve 360 may be disposed between the hydraulic turbine 320 or the flow regulator 330 and the wand 310. The electronic valve 360 may be disposed in the wand 310. The electronic valve 360 may be disposed downstream, with respect to a flow of water from the water supply to the wand 310, of the hydraulic turbine 320. In some examples, the electronic valve 360 may be disposed in the wand housing 340 or bidet base 350. The electronic valve 360 may be disposed in the wand 310. In some examples, as described hereinafter in greater detail with respect to FIG. 5, the bidet assembly 300 may include two or more electronic valves 360. The electronic valve 360 may be a solenoid valve.

According to some examples, the bidet assembly 300 may further include a battery 370 and/or a controller 380. The battery 370 may be connected to the hydraulic turbine 320. The battery 370 may be configured to store power generated by the hydraulic turbine 320. The battery 370 may be configured to provide power to the electronic valve 360 and/or the controller 380. In some examples, power generated by the hydraulic turbine 320 may travel through the controller 380 before being stored in the battery 370. In some examples, the battery 370 may be disposed in the wand housing 340 or the bidet base 350.

The controller 380 may be connected to and/or in communication with the hydraulic turbine 320 and/or the electronic valve 360. The controller 380 may be configured to provide one or more control signals and/or electric current to the electronic valve 360, controlling the electronic valve 360, causing the electronic valve to move to the (e.g., single) open position and/or the (e.g., single) closed position. The controller 380 may receive power from the hydraulic turbine 320 and/or the battery 370.

The bidet assembly 300 may further include a housing 390. The housing 390 may be disposed separately or remotely from the bidet wand 310, wand housing 340, and bidet base 350. In some examples, the housing 390 may be disposed or configured to be installed in a pedestal (e.g., 110, 210) of a toilet (e.g., to which the bidet assembly is coupled or included). In other examples, the housing 390 may be disposed or configured to be installed outside of pedestal. The housing 390 may be disposed in a position in which it does not contact (e.g., a pedestal of) the toilet. For examples, the housing 390 may be disposed or configured to be installed in a wall or floor (e.g., proximate to a toilet). In some examples, the housing may be installed at a water supply, for example, a hook-up or pipe of a potable water plumbing network. For example, the housing 390 may be installed between a hook-up or pipe of a potable water plumbing network and a toilet supply line.

The housing 390 may include an inlet 391, a first outlet 392, and a second outlet 393. The inlet may be in communication with a water supply (e.g., potable plumbing network) and configured to receive a flow of water (e.g., first flow of water) from the water supply. In some examples, the 391 may be coupled to and in fluid communication with a potable water plumbing network 301. The first outlet 392 and second outlet 393 may in communication with the inlet 391. The first outlet 392 may be configured to convey a flow of water (e.g., second flow of water) to a toilet 305 (e.g., to which the bidet assembly 300 is coupled or including the bidet assembly 300). In some examples, the first outlet 392 may be coupled to and in communication with a toilet supply line 302. In some examples, the toilet supply line 302 may convey water to a tank fill valve disposed in a toilet tank (e.g., 120). In other examples, the bidet assembly 300 may convey water to a flow controller for controlling water dispensed from a rim and/or sump of the toilet (e.g., where water is dispensed under in-line pressure, without being stored in a tank). The second outlet 393 may be configured to convey a flow of water (e.g., third flow of water) to the bidet wand 310 and the wand housing 340 and/or bidet base 350. In some examples, the second outlet 393 may be coupled to and in communication with a bidet supply line 303.

The housing 390 may further include a first channel 394, a second channel 395, and a third channel 396. The first channel 394 may be in fluid communication with the inlet 391. The second channel 395 may be in fluid communication with and extend between the first channel 394 and the first outlet 392. The third channel 396 may be in fluid communication with and extend between the first channel and the second outlet 393.

In accordance with some examples of the present disclosure, the hydraulic turbine 320 may be disposed along or within the first channel 394. Accordingly, water supplied to a toilet and the wand 310 may flow past the hydraulic turbine 320, and thus the hydraulic turbine 320 may generate power as water flows to the toilet and/or the wand 310. In accordance with some examples of the present disclosure, the hydraulic turbine 320 may be disposed along or within a channel or pathway through which water is supplied to the toilet and the wand 310, such that power may advantageously be generated when water flows to either of the toilet or the wand 310.

In accordance with some examples, the flow regulator 330 may be disposed downstream of the hydraulic turbine 320. For example, the flow regulator 330 may be disposed downstream of the hydraulic turbine 320. For example, the flow regulator 330 may be disposed downstream of the hydraulic turbine 320 so as to not reduce a flow rate of water before it travels past the hydraulic turbine 320, thus maximizing power generation of the hydraulic turbine 320. In some examples, the flow regulator 330 may be disposed along or within the third channel 396. For example, the flow regulator 330 may be disposed along the third channel 396, such that the flow of water (e.g., second flow of water) supplied to the toilet is not reduced by the flow regulator 330.

In some examples, the electronic valve 360 may also be disposed within the housing 390. For example, the electronic valve 360 may be included along or within the third channel 396. In other examples, as shown in FIG. 3, the electronic valve 360 may be disposed along or within the bidet supply line 303. In yet other examples, the electronic valve 360 may be disposed in the wand 310, wand housing 340, or bidet base 350.

In some examples, the battery 370 and/or the controller 380 may also be disposed in the housing 390.

Referring to FIG. 4, a toilet 400 is illustrated in accordance with one example of the present disclosure. As shown in FIG. 4, the toilet 400 includes the bidet assembly 300 of FIG. 3. According to some examples, the bidet assembly 300 may be coupled to the toilet 400 (e.g., as an after-market or add-on product). According to other examples of the present disclosure, toilet 400 may be manufactured to include the bidet assembly 300. As shown in FIG. 4, the toilet 400 may include the bidet wand 310, the wand housing 340, the electronic valve 360, and the housing 390 of the bidet assembly 300. The housing 390 may include the hydraulic turbine 320, the flow regulator 330, the battery 370, and the controller 380 as described above with respect to FIG. 3.

As shown in FIG. 4, the toilet 400 may include a rim channel 410, a rim outlet 420, a bowl 430, a sump 440, a sump outlet 450, and a trapway 460. The rim channel 410 may be disposed within and/or along a rim of the toilet 400. The rim channel 410 may be in fluid communication with one or more rim outlets 420 configured to dispense water into the bowl 430. The bowl 430 may be in communication with and/or include the sump 440 disposed at a bottom of the bowl 430. The sump 440 may be a receptacle configured to hold water and/or waste during an operational cycle of the toilet 400. The toilet 400 may include a sump outlet 450 configured to dispense water into the sump 440 of the bowl 430. The sump 440 may be in communication with the trapway 460. The trapway 460 may include a first portion, a second portion, and a weir separating the first and second portions. The first portion of the trapway 460 may extend from the sump 440 at an upwardly oblique angle to the weir. The second portion of the trapway 460 may extend from the weir downwardly to an exiting device such as a drain pipe or soil pipe.

In accordance with some examples of the present disclosure, the toilet 400 may include a flow controller 480. The flow controller 480 may be in fluid communication with the housing 390. Specifically, the flow controller 480 may be in fluid communication with the second outlet 393 of the housing 390. The toilet supply line 302 may extend between and be in fluid communication with the second outlet 393 of the housing 390 and the flow controller 480. The flow controller 380 may be configured to selectively supply water to the rim outlet 420 and/or the sump outlet 450.

The flow controller 480 may include a rim valve 481 configured to selectively supply water to the rim outlet 420. The rim valve 481 may be an electronic or solenoid valve. The rim valve 481 may be in fluid communication with the first outlet 392 of the housing 390. The rim valve 481 may be connected to and receive power from the hydraulic turbine 320 and/or battery 370. The rim valve 481 may be connected to and/or in communication with the controller 380. The controller 380 may provide one or more control signals and/or power to the rim valve 481, controlling the rim valve 481. For example, the controller 380 may control the rim valve 481 so as to actuate between an open position in which water is provided to a rim outlet 420 and a closed position in which water is not provided to a rim outlet 420.

The flow controller 480 may include a sump valve 482 configured to selectively supply water to the sump outlet 450. The sump valve 482 may be an electronic or solenoid valve. The sump valve 482 may be in fluid communication with the first outlet 392 of the housing 390. The rim valve 482 may be connected to and receive power from the hydraulic turbine 320 and/or the battery 370. The sump valve 482 may be connected to and/or in communication with the controller 380. The controller 380 may provide one or more control signals and/or power to the sump valve 482, controlling the rim valve 482. For example, the controller 380 may control the sump valve 482 so as to actuate between an open position in which water is provided to a sump outlet 450 and a closed position in which water is not provided to the sump outlet 450.

In other examples, the toilet 400 may include a tank (e.g., 120) and the first outlet 392 of the housing 390 may be in fluid communication with a tank fill valve disposed within the tank of the toilet. For example, the toilet supply line 302 may extend between the first outlet 392 of the housing 390 and the tank fill valve. In these examples, a gravity-fed flush assembly including, for example, the fill valve and a flush valve, may selectively provide water to the rim outlet 420 and/or a sump outlet 450.

Referring to FIG. 5, a cross-sectional view of a bidet wand 310 is illustrated in accordance with one example of the present disclosure. As shown in FIG. 5, the wand 310 may include a wand channel 510, a rear wash outlet 520, a rear wash electronic valve 530, a front wash outlet 540, a front wash electronic valve 550, a mist outlet 560, a mist electronic valve 570, and an ultraviolet (UV) light 580. As shown in FIG. 5, the wand 310 may include a proximal end 501 disposed at or coupled to the wand housing 340 and a distal end 502 disposed opposite the proximal end 501. The distal end 502 may be disposed nearer to a center of the bowl (e.g., 430) than the proximal end 501.

The wand channel 510 may be in fluid communication with and configured to receive a flow of water (e.g., third flow of water) from the second outlet 393 of the housing 390. The wand channel 510 may be in fluid communication with and configured to receive water conveyed by the bidet supply line 303. In some examples, the wand housing 340 and the bidet base 350 may include a bidet housing channel 590 and a bidet base channel, respectively. In these examples, the bidet housing channel 590 and bidet base channel may be in fluid communication with the bidet supply line 303 and the wand channel 510 and disposed between the bidet supply line 303 and the wand channel 510.

According to some examples, as shown in FIG. 5, the wand 310 may include a rear wash channel 511 extending between the wand channel 510 and the rear wash outlet 520. In some examples, the rear wash outlet 520 may be disposed on a front side of the wand 310 facing a center of the bowl (e.g., 430). According to the present disclosure, the rear wash outlet 520 may be configured to dispense a flow of water (e.g., a rear wash flow). In some examples, the rear wash outlet 520 may include one or more nozzles configured to direct or otherwise control a flow of water dispensed from the rear wash outlet 520. The rear wash outlet 520 may be configured to dispense a flow of water, such that the flow of water contacts a rear portion of a bottom of a user (e.g., sitting on a toilet), washing a rear of the user. Specifically, a position and/or an orientation of the rear wash outlet 520 and/or a nozzle included in the rear wash outlet 520 may direct a flow of water dispensed by the rear wash outlet 520 such that the flow of water contacts a rear portion of the bottom of the user.

According to some examples, as shown in FIG. 5, the wand 310 may include a front wash channel 512 extending between the wand channel 510 and the front wash outlet 540. In some examples, the front wash outlet 540 may be disposed on a front side of the wand 310, facing a center of the bowl (e.g., 430). According to the present disclosure, the front wash outlet 540 may be configured to dispense a flow of water (e.g., a front wash flow). The front wash outlet 540 may include one or more nozzles configured to direct or otherwise control a flow of water dispensed from the front wash outlet 540. The front wash outlet 540 may be configured to dispense a flow of water, such that the flow of water contacts a front portion of a bottom of a user (e.g., sitting on the toilet), washing the front of the user. A position and/or an orientation of the front wash outlet 540 and/or a nozzle included in the front wash outlet 540 may direct a flow of water dispensed by the front wash outlet 540 such that the flow of water contacts a front portion of the bottom of the user. In some examples, the front wash outlet 540 may be disposed nearer to the distal end 502 of the wand 310 than the rear wash outlet 520.

According to some examples, as shown in FIG. 5, the wand 310 may include a mist outlet channel 513 extending between the wand channel 510 and the mist outlet 560. In some examples, the mist outlet 560 may be disposed on a back of the wand 310 facing a back of the bowl (e.g., 430). The mist outlet 560 may be configured to dispense a fluid (e.g., water) onto a surface of the bowl (e.g., 430). In some examples, the mist outlet 560 may include a nozzle, such that a mist of fluid is dispensed or sprayed on to a surface of the bowl (e.g., 430). According to some examples, a mist of fluid may be sprayed onto a surface of the bowl, before the toilet is used by a user, preventing waste from sticking to a surface of the bowl (e.g., 430). For example, the mist outlet 560 may dispense a mist of water onto a surface of the bowl at the back of the bowl, preventing waste from sticking to the back surface of the bowl, when waste is deposited into the bowl by a user.

As noted above, the wand 310 may further include a rear wash electronic valve 530, a front wash electronic valve 550, and a mist electronic valve 570, configured to selectively provide water to the rear wash outlet 520, the front wash outlet 540, and the mist outlet 560, respectively, and thus control whether a flow or mist is dispensed from the rear wash outlet 520, front wash outlet 540, and the mist outlet 560, respectively. According to the present disclosure, each of the rear wash electronic valve 530, front wash electronic valve 550, and mist electronic valve 570 may be an electronic valve 360 as described above with respect to the bidet assembly 300 of FIG. 3. For example, each of the rear wash electronic valve 530, front wash electronic valve 550, and mist electronic valve 570 may be a binary valve configured to actuate or move between a single open position and a single closed position and may not be configurable or operable to open a variable degree. Providing the rear wash electronic valve 530, front wash electronic valve 550, and/or mist electronic valves 570 as binary valves may reduce power requirements and/or the complexity of a system for controlling the respective valves.

According to the present disclosure, a hydraulic turbine (e.g., 320) may be configured to generate power for each of the rear wash electronic valve 530, front wash electronic valve 550, and mist electronic valve 570. In some examples, the hydraulic turbine (e.g., 320) may supply power directly to the rear wash electronic valve 530, front wash electronic valve 550, and/or mist electronic valve 570. According to the present disclosure, the rear wash electronic valve 530, the front wash electronic valve 550, and/or the mist electronic valve 570 may exclusively receive power generated by the hydraulic turbine 320. In other examples, power generated by the hydraulic turbine may be stored in a battery (e.g., 370) and the battery may be configured to provide power to the rear wash electronic valve 530, front wash electronic valve 550, and/or mist electronic valve 570.

According to the present disclosure, the rear wash electronic valve 530, front wash electronic valve 550, and/or the mist electronic valve 570 may be connected to and/or in communication with the controller 380. The controller 380 may be configured to control the rear wash electronic valve 530, front wash electronic valve 550, and/or mist electronic valve 570. For examples, the controller 380 may provide one or more control signals and/or power to the rear wash electronic valve 530, front wash electronic valve 550, and/or mist electronic valve 570, for controlling a position (e.g., open position, closed position) of the rear wash electronic valve 530, front wash electronic valve 550, and/or mist electronic valve 570, respectively. In accordance with some examples of the present disclosure, when one or more of the rear wash electronic valve 530, front wash electronic valve 550, and mist electronic valve 570 are included in the wand 310, the electronic valve 360 may be omitted from the bidet assembly 300 and the rear wash electronic valve 530, the front wash electronic valve 550, and the mist electronic valve 570 may control a flow of water dispensed from the rear wash outlet 520, front wash outlet 540, and mist outlet 560, respectively. According to some examples of the present disclosure, the wand channel 510 may be omitted and each of the rear wash channel 511, front wash channel 512, and/or mist outlet channel 513 may be in fluid communication with and/or extend from the bidet supply line 303. In these examples, a flow regulator 330 may be disposed along the rear wash channel 511, the front wash channel 512, and/or the mist outlet channel 513 and may be configured to control a flow rate, velocity, and/or a pressure of water dispensed by the rear wash outlet 520, front wash outlet 540, and/or the mist outlet 560, respectively.

According to some examples, the wand 310 may further include a UV light 580. The UV light 580 may be disposed within the wand 310 and configured to irradiate or illuminate a portion of the wand channel 510 and water disposed in (e.g., flowing through) the wand channel 510. Specifically, the UV light 580 may be configured to irradiate or illuminate a portion of the wand channel 510 and/or water disposed (e.g., flowing) within the wand channel, so as to disinfect a portion of the wand channel 510 and/or water irradiated or illuminated by the UV light 580. According to some examples, a portion or window 515 of a wall of the wand channel 510 adjacent to the UV light 580 may be comprised of a transparent material, such that UV light emitted (e.g., irradiated) by the UV light 580 may impinge on or illuminate a portion of the wand channel 510 and/or water disposed in the wand channel 510.

In some examples, a hydraulic turbine 320 of the bidet assembly 300 may be configured to generate power for consumption by the UV light 580. In some examples, the hydraulic turbine 320 may be connected to the UV light 580 and power may be directly supplied to the UV light 580 (e.g., as water flows past the hydraulic turbine 320, causing the hydraulic turbine 320 to generate power). In some examples, the UV light 580 may be connected to a battery 370 of the bidet assembly 300. The battery 370 may be configured to store power generated by the hydraulic turbine 320 and provide stored power to the UV light 580. According to some examples, the UV light 580 may exclusively receive power generated by the hydraulic turbine 320.

In some examples, the UV light 580 may be connected to a controller 380 of the bidet assembly 300. The controller 380 may provide one or more control signals and/or power to the UV light 580, controlling the UV light 580. Specifically, the controller 380 may provide one or more control signals and/or power to the UV light 580 causing the UV light 580 to start and/or stop emitting UV light.

According to some examples, the flow regulator 330 may be actuated by a user to control the flow rate and/or pressure of water dispensed from each of the rear wash outlet 520, the front wash outlet 540, and/or the mist outlet 560. Specifically, water may flow through the flow regulator 330 before being provided to each of the rear wash outlet 520, front wash outlet 540, and mist outlet 560. In accordance with other examples, of the present disclosure, water may flow through a respective flow regulator 330 disposed along the rear wash channel 511, the front wash channel 512, and/or the mist outlet channel 513, before being dispensed from the rear wash outlet 520, front wash outlet 540, or the mist outlet 560.

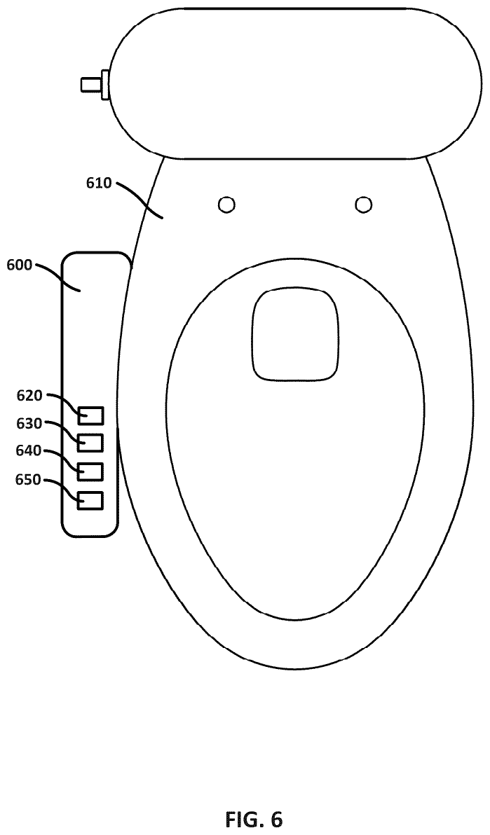

Referring to FIG. 6 a top view of the bidet assembly 300 is illustrated in accordance with one example of the present disclosure. As shown in FIG. 6, in some examples, the bidet assembly 300 may further include a control panel 600. In some examples, as shown in FIG. 6, the control panel 600 may extend from the base or pedestal 610 of a toilet. For example, the control panel 600 may extend from a base or pedestal (e.g., 110, 210) of any of the toilets 100, 200, 400 described herein. In other examples, the control panel 600 may extend from a bidet base 350 of the bidet assembly 300.

In some examples, as shown in FIG. 6, the control panel 600 may be disposed adjacent or next to a pedestal 610 and/or bowl of the toilet. For example, the control panel 600 may be disposed adjacent to a left or right (e.g., as shown in FIG. 6) side of pedestal 610 and/or bowl of the toilet. The control panel 600 may include one or more user input devices 620, 630, 640, 650 connected to or in communication with a controller 380 of the bidet assembly 300. Each of the one or more user input devices 620, 630, 640, 650 may be configured to transmit one or more user input signals to the controller 380 in response to actuation by a user. The user input devices 620, 630, 640, 650 may include tactile (e.g., movable) buttons and/or one or more sensors (e.g., capacitive sensors) configured to receive an input from a user when a user is proximate to the sensor (e.g., when a user contacts a surface behind which the sensor is disposed). The controller 380 may be configured to receive user input signals from each of the user input devices 620, 630, 640, 650 and may control one or more components or elements of the bidet assembly 300 in accordance with the user input signals.

As shown in FIG. 6, the control panel 600 may include a first user input device 620. The first user input device 620 may be a rear wash user input device configured to provide one or more user input signals related to operation of the rear wash electronic valve 530 of the bidet assembly 300 to the controller 380. The controller 380 may be configured to receive the one or more user input signals and control the rear wash electronic valve 530 in accordance with the various user input signals. The first user input device 620 may be configured to provide user input signals to the controller 380 causing the controller 380 to open the rear wash electronic valve 530, such that a flow of water is dispensed from the rear wash outlet 520, and/or close the rear wash electronic valve 530, such that a flow water being dispensed from the rear wash outlet 520 is stopped.

As shown in FIG. 6, the control panel 600 may further include a second user input device 630. The second user input device 630 may be a front wash user input device configured to provide one or more user input signals related to operation of the front wash electronic valve 550 of the bidet assembly 300 to the controller 380. The controller 380 may be configured to receive the one or more user input signals and control the front wash electronic valve 550 in accordance with the various user input signals. The second user input device 630 may be configured to provide user input signals to the controller 380 causing the controller 380 to open the front wash electronic valve 550, such that a flow of water is dispensed from the front wash outlet 540, and/or close the front wash electronic valve 550, such that a flow water being dispensed from the front wash outlet 540 is stopped.

As shown in FIG. 6, the control panel 600 may further include a third user input device 640. The third user input device 640 may be a mist input device configured to provide one or more user input signals related to operation of the mist electronic valve 570 of the bidet assembly 300 to the controller 380. The controller 380 may be configured to receive the one or more user input signals and control the mist electronic valve 570 in accordance with the various user input signals. The third user input device 640 may be configured to provide user input signals to the controller 380 causing the controller 380 to open the mist electronic valve 570, such that a spray or mist of water is dispensed from the mist outlet 560, and/or close the mist electronic valve 570, such that a spray or mist of water being dispensed from the mist outlet 560 is stopped.

As shown in FIG. 6, the control panel 600 may further include a fourth user input device 650. The fourth user input device 650 may be a UV light input device configured to provide one or more user input signals related to operation of the UV light 580 to the controller 380 of the bidet assembly 300. The controller 380 may be configured to receive the one or more user input signals and control the UV light 580 in accordance with the various user input signals. The fourth user input device 650 may be configured to provide user input signals to the controller 380 causing the controller 380 to turn on the UV light 580, causing the UV light 580 to illuminate the wand channel 510 and/or water disposed within the wand channel 510, and/or turn off the UV light 580 causing the UV light to stop illuminating the wand channel 510 and/or water disposed within the wand channel 510.

In some examples, the controller 380 may control the UV light 580 to emit or irradiate UV light, illuminating the wand channel 510 and water disposed within the wand channel 510 any time that water is dispensed from the rear wash outlet 520, front wash outlet 540, or the mist outlet 560.

In some examples, the bidet assembly 300 may include two control panels 600. For examples, the bidet assembly 300 may include a control panel disposed on each of a left and right side of the pedestal 610 and/or a bowl of the toilet. One or more user input devices 620, 630, 640, 650 may be provided on each of the control panels 600.

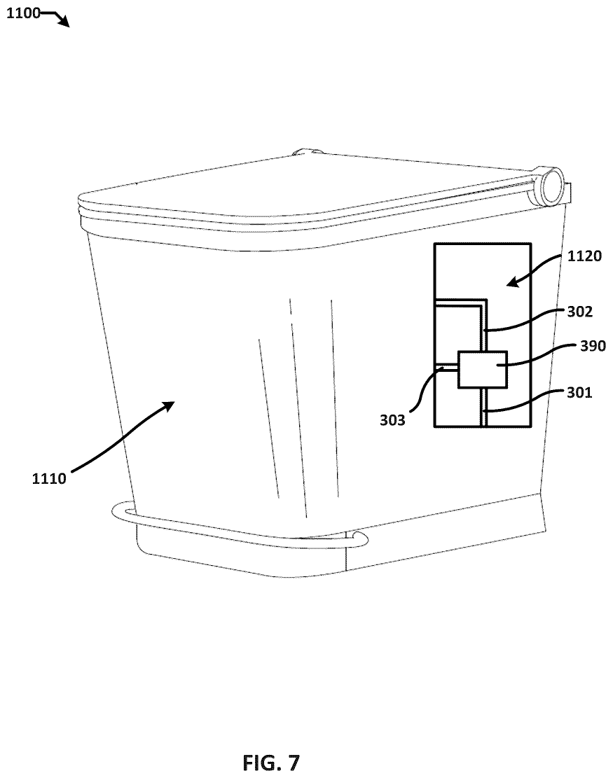

Referring to FIG. 7, a toilet 1100 is illustrated in accordance with one example of the present disclosure. The toilet 1100 may be the same or substantially similar to any of the toilets 100, 200, 400 described herein with respect to FIGS. 1, 2, and 4. The toilet 1100 may include the bidet assembly 300 described above with respect to FIG. 3. In some examples, the toilet 1100, as manufactured and initially sold may include the bidet assembly 300. In other examples, the bidet assembly 300 may be coupled to the toilet 1100 as an after-market or add-on product.

As shown in FIG. 7, the toilet 1100 includes a shroud or pedestal 1110. In some examples, the pedestal 1110 may include an opening 1120 providing access to an interior of the pedestal 1110. A movable door or panel may be (e.g., removably) coupled to the pedestal 1110 and configured to selectively provide access to an interior of the pedestal 1110. In some examples, as shown in FIG. 7, the housing 390 of the bidet assembly 300 including, for example, the hydraulic turbine 320, flow regulator 330, and/or electronic valve 360 may be disposed within the pedestal 1110 of the toilet 1100. The housing 390 may be provided within the pedestal 1110 of the toilet 1100, such that the housing 390 including the flow regulator 330 may be hidden from sight, while still being accessible and proximate to the toilet 1100, such that a user may manipulate or move the actuator of the flow regulator 330, adjusting the flow rate and/or pressure of water dispensed from one or more of a rear wash outlet 520, front wash outlet 540, and mist outlet 560 included in the bidet wand 310.

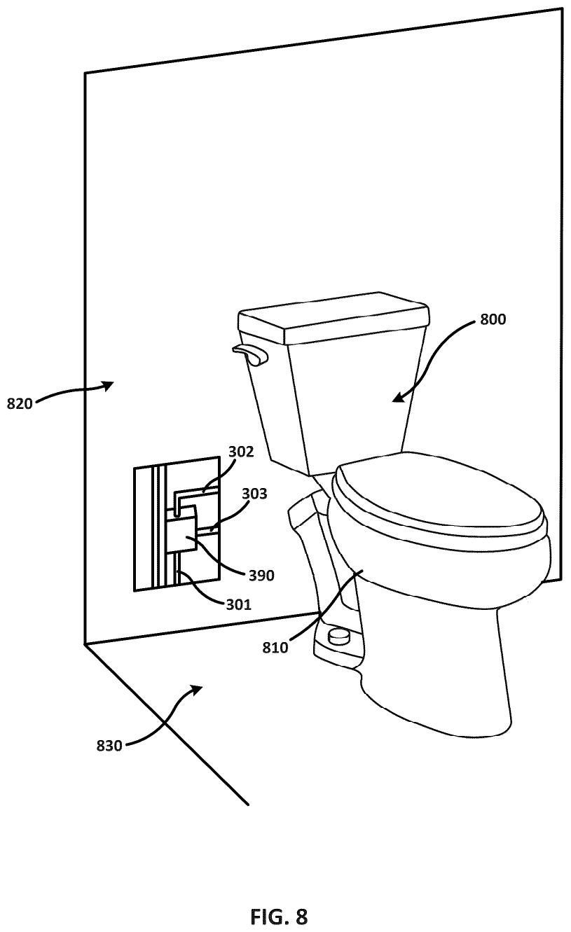

Referring to FIG. 8, a toilet 800 is illustrated in accordance with one example of the present disclosure. The toilet 800 may be the same or substantially similar to any of the toilets 100, 200, 400 described herein with respect to FIGS. 1, 2, and 4. The toilet 800 may include the bidet assembly 300 described above with respect to FIG. 3. In some examples, the toilet 800, as manufactured and initially sold may include the bidet assembly 300. In other examples, the bidet assembly 300 may be coupled to the toilet 800 as an after-market or add-on product.

According to some examples, as shown in FIG. 8, the housing 390 may be disposed outside of and remotely from a pedestal 810 of the toilet 800. In some examples, as illustrated in FIG. 8, the housing 390 including, for example, the hydraulic turbine 320, flow regulator 330, and/or electronic valve 360 may be disposed within a wall 820 proximate to the toilet 800. In other examples, the housing 390 may be attached or mounted to an (e.g., exterior) surface of the wall 820. In yet other examples, the housing may be disposed on (e.g., place on, attached to) or within a floor 830, for example, proximate to the toilet 800.

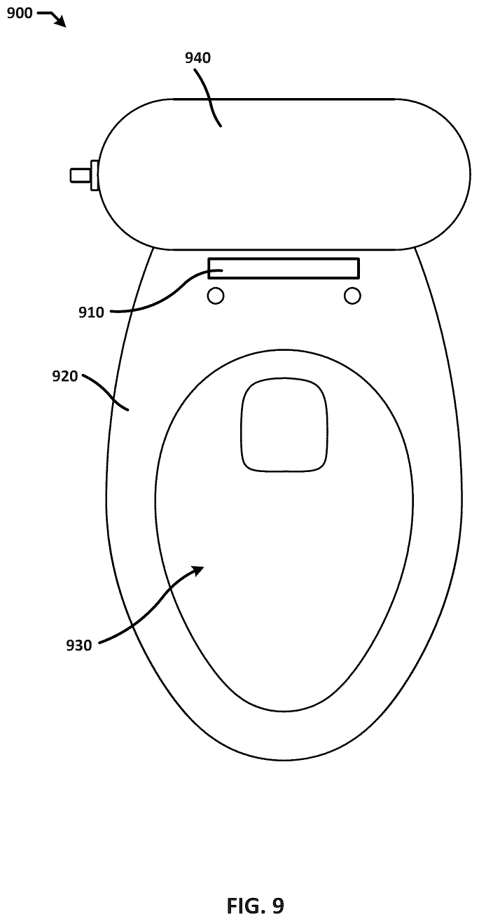

Referring to FIG. 9, a toilet 900 is illustrated in accordance with one example of the present disclosure. The toilet 900 may be the same or substantially similar to any of the toilets 100, 200, 400 described herein with respect to FIGS. 1, 2, and 4. The toilet 400 may include the bidet assembly 300 described above with respect to FIG. 3; however, instead of including a hydraulic turbine 320, the bidet assembly 300 may include one or more photovoltaic or solar panels 910 configured to generate power for consumption by one or more of the electronic valve 360, controller 380, rear wash electronic valve 530, front wash electronic valve 550, mist electronic valve 570, and UV light 580.

The solar panel 910 may be configured to generate power by converting light energy into electricity using the photovoltaic affect. The solar panel 910 may include one or more photovoltaic or solar cells. In some examples, the bidet assembly 300 may further include an inverter configured convert power generated by the solar panel 910 (e.g., from direct to alternating current). The solar panel 910 may be connected to the battery 370 and/or controller 380 of the bidet assembly 300. The battery 370 may be configured to store power generated by the solar panel 910 and provide stored power to the electronic valve 360, controller 380, rear wash electronic valve 530, front wash electronic valve 550, mist electronic valve 570, and/or UV light 580. According to some examples, the electronic valve 360, controller 380, rear wash electronic valve 530, front wash electronic valve 550, mist electronic valve 570, and/or UV light 580 may be powered solely using power generated by the solar panel 910. Accordingly, the bidet assembly 300 may be provided as a stand-alone of self-sustaining system that does not require power from an external source, for example, a wall outlet.

As shown in FIG. 9, the toilet 900 may include a base or pedestal 920, bowl 930 disposed in the pedestal 920, and a tank 940. Although illustrated in FIG. 9 as included in a toilet 900 including a tank 940, one or more solar panels 910 may be included in a tankless toilet (e.g., 200, 400) in accordance with another example of the present disclosure. According to some examples, as shown in FIG. 9, one or more solar panels 910 may be disposed on a top or upper surface of a pedestal 920 of the toilet 900. For example, one or more solar panels 910 may be disposed on a top surface of the pedestal 920 behind the bowl 930, for example, between the bowl 930 and a tank 940 of the toilet 900. In some examples, one or more solar panels 910 may be disposed on a side and/or top surface of a tank 940 of the toilet 900. In some examples, one or more solar panels 910 may be disposed on a seat assembly (e.g., 130, 230) of the toilet 900. For example, one or more solar panels 910 may be disposed on a hinge assembly or hinge cover of the seat assembly (e.g., 130, 230) and/or on a top surface of a seat cover (e.g., 132, 232). In some examples, one or more solar panels 910 may be disposed on the housing 390. Other locations are possible and one or more solar panels may be disposed on any exterior surface of the toilet 900.

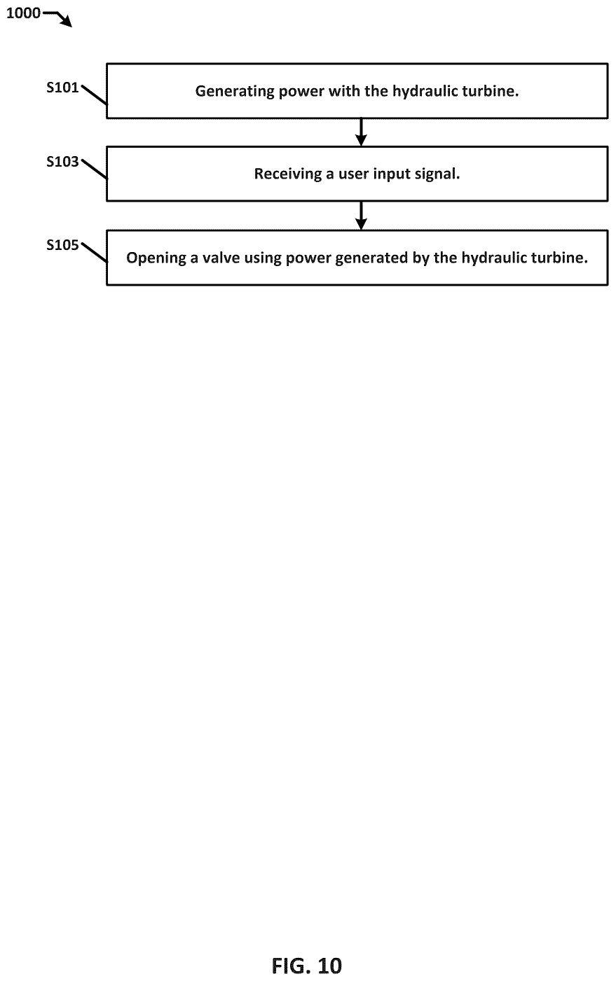

Referring to FIG. 10, a flow chart 1000 for operating a bidet assembly 300 is illustrated in accordance with one example of the present disclosure. The flow chart 1000 for operating a bidet assembly 300 may be used in combination with any of the toilets 100, 200, 400, 1100, 800 described herein. Additional, different, or fewer acts may be provided.

In a first act S101, power may be generated by the hydraulic turbine 320. According to the present disclosure, power may be generated as water flows through a pathway or conduit including the hydraulic turbine 320 to a toilet including or to which the bidet assembly 300 is coupled and/or a bidet wand 310. Specifically, power may be generated as water flows through a pathway or conduit in which an impeller of the hydraulic turbine is disposed, rotating the impeller. According to some examples, power generated by the hydraulic turbine 320 may be stored in the battery 370.

In a second act S103, a user input signal may be received. Specifically, the controller 380 may receive a user input signal from one of the user input devices 620, 630, 640, 650 disposed on a control panel 600 of the bidet assembly 300. For example, the controller 380 may receive a user input signal when a user actuates one of the user input devices 620, 630, 640, 650.

In a third act S103, the controller 380 may provide one or more control signals to the electronic valve 360, the rear wash electronic valve 530, the front wash electronic valve 550, and/or the mist outlet valve 570, opening the respective valve(s) using power generated by the hydraulic turbine 320 and causing water to be dispensed from the rear wash outlet 520, front wash outlet 540, and/or mist outlet 560.

In accordance with some examples of the present disclosure, the flow chart 1000 may further include an act of adjusting or setting the flow regulator 330. For example, a user may manually adjust, set, or change a position of the flow regulator 330, and thus, a flow rate, velocity, and/or pressure of a flow of water dispensed from one or more of the rear wash outlet 520, front wash outlet 540, or mist outlet 560. For example, a user may physically move an actuator 331 of the flow regulator, changing a position of the flow regulator 330.

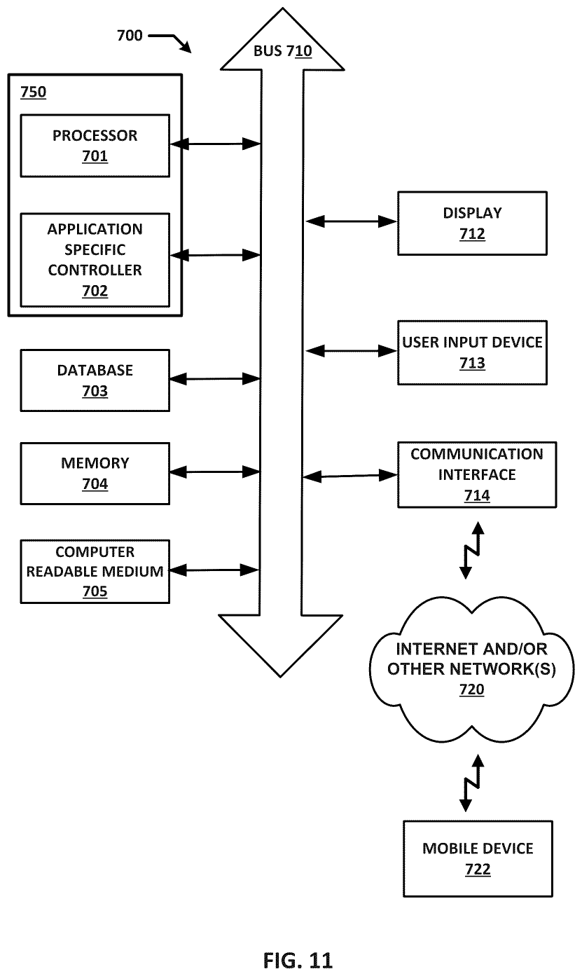

Referring to FIG. 11, an apparatus 700 for facilitating operation of a bidet assembly 300 is illustrated in accordance with one example of the present disclosure. The apparatus 700 includes a bus 710 facilitating communication between a controller 750 that may be implemented by a processor 701 and/or application specific controller 702 and one or more components including a database 703, a memory 704, a computer readable medium 705, display 712, a user input device 713, and a communication interface 714.

The memory 704 may be a volatile memory or a non-volatile memory. The memory 704 may include one or more read only memory (ROM), random access memory (RAM), a flash memory, an electronic erasable program read only memory (EEPROM), or other type of memory. The memory 704 may be removable from the apparatus 700, such as a secure digital (SD) memory card.

The memory 704 and/or the computer readable medium 705 may include a set of instructions that can be executed to cause the controller 750 to perform any one or more of the methods or computer-based functions disclosed herein. For example, the controller 750 may send one or more controller signals and/or electric current to the electronic valve 360, rear wash electronic valve 530, front wash electronic valve 550, mist outlet electronic valve 570, opening or closing the respective valves.

A user may cause the wand 310 to dispense a rear wash flow, a front wash flow, or a spray or mist of water and/or turn on the UV light 580 using the display 712 and/or the user input device 713. The user input device 713 may include the first user input device 620, second user input device 630, third user input device 640, and/or fourth user input device 640. The display 712 may comprise a screen. In some embodiments, the display 712 and user input device 713 may comprise a touch sensitive surface (i.e., a touch screen).

The communication interface 714 may be connected to the network 720, which may be the internet. In some embodiments, the network 720 may be connected to one or more mobile devices 722. The one or more mobile devices may be configured to send a signal to the communication interface 714 via the network 720. For example, a more mobile devices may send a signal to the communication interface to dispense a rear wash flow, a front wash flow, or a spray or mist of water and/or turn on the UV light 580.

The communication interface 714 may include any operable connection. An operable connection may be one in which signals, physical connections and/or logical communications may be sent and/or received. An operable connection may include a physical interface, an electrical interface, and/or a data interface. The communication interface 714 provides for wireless and/or wired communications in any known or later developed format.

When a component, device, element, or the like of the present disclosure is described as having a purpose or performing an operation, function, or the like, the component, device, or element should be considered herein as being “configured to” meet that purpose or to perform that operation or function.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A bidet comprising:
a wand configured to be coupled to a toilet and dispense a flow of water;
a manual flow regulator configured to control a flow rate of the flow of water dispensed by the wand;
a hydraulic turbine configured to generate power as water is supplied to the toilet or the wand; and
an electronic valve configured to control the flow of water dispensed from the wand using power generated by the hydraulic turbine.

2. The bidet of claim 1, further comprising:
a housing including the hydraulic turbine and the manual flow regulator,
wherein the hydraulic turbine is configured to generate power as water is supplied to the toilet and as water is supplied to the wand.

3. The bidet of claim 2, wherein the housing is disposed in a pedestal of the toilet.

4. The bidet of claim 2, wherein the housing is disposed outside and remote from the toilet.

5. The bidet of claim 4, wherein the housing is disposed within a floor or wall.

6. The bidet of claim 2, wherein the housing includes the electronic valve.

7. The bidet of claim 1, wherein:
the wand includes a rear wash outlet, the flow of water is a rear wash flow of water dispensed from the rear wash outlet, and the electronic valve is a rear wash electronic valve configured to control the rear wash flow of water dispensed from the rear wash outlet; and
the wand includes a front wash outlet and a front wash electronic valve configured to control a front wash flow of water dispensed from the front wash outlet.

8. The bidet of claim 1, wherein the wand includes a mist outlet configured to wet a surface of a bowl of the toilet and a mist outlet electronic valve configured to control fluid dispensed from the mist outlet.

9. The bidet of claim 1, wherein the wand includes an ultraviolet light configured to illuminate water in the wand using power generated by the hydraulic turbine.

10. A bidet assembly comprising:
a wand configured to extend into a bowl of a toilet and dispense water;
a housing including a flow regulator configured to control a flow rate of water dispensed from the wand and a hydraulic turbine configured to generate power as water flows to the wand or the toilet; and
an electronic valve configured to control water dispensed from the wand using power generated by the hydraulic turbine.

11. The bidet assembly of claim 10, wherein the hydraulic turbine is configured to generate power as water flows to the wand and as water is supplied to the toilet.

12. The bidet assembly of claim 10, wherein the housing includes an inlet configured to receive a first flow of water, a first outlet configured to convey a second flow of water to the toilet, and a second outlet configured to convey a third flow of water to the wand.

13. The bidet assembly of claim 12, wherein the housing includes a first channel in fluid communication with the inlet, a second channel in fluid communication with and extending between the first channel and the first outlet, and a third channel in fluid communication with and extending between the first channel and the second outlet, the flow regulator disposed along the second channel and configured to control a flow rate of the third flow of water.

14. The bidet assembly of claim 13, wherein the hydraulic turbine is disposed along the first channel and is configured to generate power as water flows through the first channel.

15. The bidet assembly of claim 10, wherein the housing is disposed in a pedestal of the toilet.

16. The bidet assembly of claim 10, wherein the housing is disposed outside of the toilet.

17. A toilet comprising:
a bowl;
a bidet including a wand extending into the bowl, the wand configured to dispense a flow of water;
a manual flow regulator configured to control a rate of the flow of water dispensed from the wand;
a hydraulic turbine configured to generate power as water is supplied to the toilet;
a battery configured to store power generated by the hydraulic turbine; and
an electronic valve configured to control the flow of water dispensed from the wand using power received from the battery.

18. The toilet of claim 17, further comprising a tank,
wherein the hydraulic turbine is configured to generate power as water is supplied to the tank.

19. The toilet of claim 17, further comprising a flow controller configured to selective provide water to a rim outlet or a sump outlet.

20. The toilet of claim 19, wherein the flow controller is connected to and receives power from the battery.
